(19) United States
(12) Patent Application Publication
(10) Pub. No.: US 2020/0147836 A1
(43) Pub. Date: May 14, 2020

(54) Tile Cutting Hand Tool

(71) Applicant: Justino Campuzano, Orlando, FL (US)

(72) Inventor: Justino Campuzano, Orlando, FL (US)

(21) Appl. No.: 16/678,597

(22) Filed: Nov. 8, 2019

Related U.S. Application Data
(60) Provisional application No. 62/757,494, filed on Nov. 8, 2018.

(51) Int. Cl. B28D 1/22; B28D 7/04

(52) U.S. Cl. CPC B28D 1/225; B28D 7/043

(57) ABSTRACT

A tile cutting hand tool. The tile cutting hand tool includes a trapezoidal planar base. The planar base has a guide bar attached thereto by a first guide bar connector and a second guide bar connector. The guide bar has a slidable scoring device placed thereon. The slidable scoring device has a handle and a scoring blade. The scoring blade is capable of scoring tile. The planar base has a plurality of base supports located on a bottom side of the planar base. The base supports allow the base to be extendable. The planar base has a ruler placed thereon. The ruler is placed perpendicular to the guide bar.

### CROSS REFERENCE TO RELATED APPLICATIONS

This application claims the benefit of U.S. Provisional Application No. 62/757,494 filed on Nov. 8, 2018. The above identified patent application is herein incorporated by reference in its entirety to provide continuity of disclosure.

### BACKGROUND OF THE INVENTION

The present invention relates to a tile cutting hand tool. More particularly, the present invention provides a tile cutting hand tool.

Tile is a popular choice for flooring or, in some cases, wall cover in homes or other buildings. Tile can be difficult to fit and place properly in the area that it is needed. Traditionally, tile needs to be cut using a special tile saw or a diamond tipped saw blade. When tile is cut using a saw blade, a large amount of dust is produced and sent into the air. Water can be added to the cutting process to eliminate the dust.

These traditional methods of cutting tile can be extremely messy and special saws can be expensive and heavy. Further, a connection to water will need to be present in most cases. This can complicate matters, as a new home or building may not have running water available. This would mean that a water source would have to be brought to the construction site.

Consequently, there is a need in for an improvement in the art of cutting tile for flooring. The present invention substantially diverges in design elements from the known art while at the same time solves a problem many people face when cutting tile. In this regard the present invention substantially fulfills these needs.

### SUMMARY OF THE INVENTION

The present invention provides a tile cutting hand tool wherein the same can be utilized for providing convenience for the user when cutting tile. The tile cutting hand tool includes a planar base having at least a first side and a second side. A first guide bar connector rising vertically from the planar base on the first side and a second guide bar connector rising vertically from the planar base on the second side. A guide bar connected to the first guide bar connector and the second guide bar connector. A scoring device slidably attached to the guide bar. The scoring device having a handle and a scoring blade.

Another object of the tile cutting hand tool is to have the scoring blade be a diamond tip blade.

Another object of the tile cutting hand tool is to have the planar base be trapezoidal.

Another object of the tile cutting hand tool is to have a ruler placed on one side of the planar base, wherein the ruler is perpendicular to the guide bar.

Another object of the tile cutting hand tool is to have a ruler placed on one side of the planar base, wherein the ruler is horizontal with the guide bar.

Another object of the tile cutting hand tool is to have the first guide bar connector and the second guide bar connector be adjustable in a vertical height.

Another object of the tile cutting hand tool is to have a pair of base supports located on a bottom side of the planar base.

Another object of the tile cutting hand tool is to have the base supports allow for the tool to be extended.

Another object of the tile cutting hand tool is to have the base supports be telescopic.

Another object of the tile cutting hand tool is to have the planar base have a plurality of apertures placed therethrough to allow for a securing the device to a surface.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the tile cutting hand tool.

FIG. 2 shows a side view of an embodiment of the tile cutting hand tool.

FIG. 3 shows a top down view of an embodiment of the tile cutting hand tool.

FIG. 4 shows a perspective in use view of an embodiment of the tile cutting hand tool.

### DETAILED DESCRIPTION OF THE INVENTION

Reference is made herein to the attached drawings. Like reference numerals are used throughout the drawings to depict like or similar elements of the tile cutting hand tool. For the purposes of presenting a brief and clear description of the present invention, a preferred embodiment will be discussed as used for the tile cutting hand tool. The figures are intended for representative purposes only and should not be considered to be limiting in any respect.

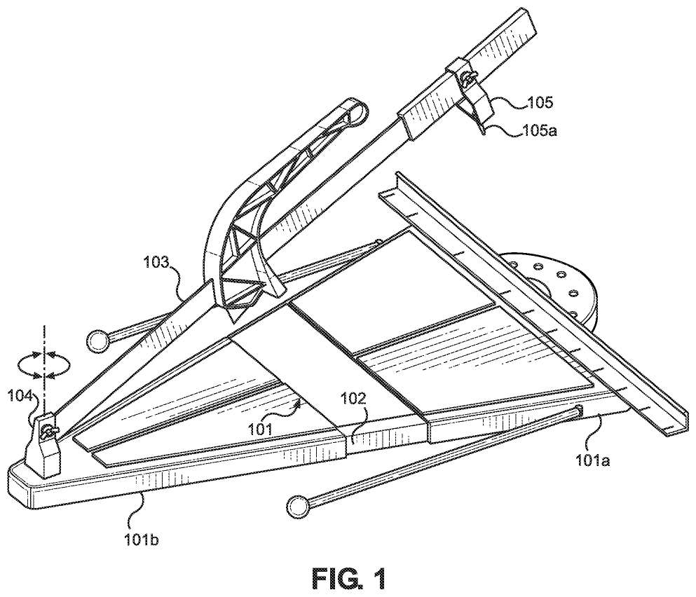

Referring now to FIG. 1, there is shown a perspective view of an embodiment of the tile cutting hand tool. The tile cutting hand tool includes a planar base 101. In one embodiment, the planar base 101 is triangular. This triangular shape is beneficial because it will reduce the weight of the planar base while still maintaining the structural function of the planar base 101. In one embodiment, the planar base 101 is made from aluminum. This will further help to reduce weight. In another embodiment, the planar base 101 is made from plastic. In other embodiments, the planar base 101 is made from any suitable material.

The planar base 101 has an adjustable length. In one embodiment, this is done by allowing the planar base 101 to have two separate parts: a first part 101a and a second part 101b. In one embodiment, the first part 101a and the second part 101b are held together via a (plurality of guide rods 102. In a version of this embodiment, the first part 101a and the second part 101b are configured to slide together and apart on the guide rods 102. In another version, the plurality of guide rods 102 are telescopic. This will allow the length of the planar base 101 to be changeable.

A slide bar 103 is attached to the planar base 101. In one embodiment, the slide bar 103 is a telescope bar. In another embodiment, the slide bar 103 is a single elongated bar. The slide bar 103 is attached to the planar base 101 using two connectors 104, 105. The first connector 104 is rotatably affixed to the planar base 101. The first connector 104 is (pivotally?) connected to the planar base 101 such that the slide bar 103 is rotatable in a horizontal plane. The slide bar 103 is movably attached to the first connecter 104. The slide bar 103 is attached such that it is movable in a vertical plane.

The second connector 105 is removably attached to the planar base 101. In one embodiment, the second connector 105 is slidably connected to the slide bar 103. In an embodiment where the second connector is slidably attached to the slide bar 103. In one embodiment, there is a securement device 105b placed therein. The securement device 105b will lock the second connector in a desired location on the slide bar 103. In another embodiment the second connector 105 is affixed to the slide bar 103. The second connector 105 has a pin 105a located on a bottom portion thereof. The pin 105a is configured to fit within apertures located on the planar base 101 as described in FIG. 3.

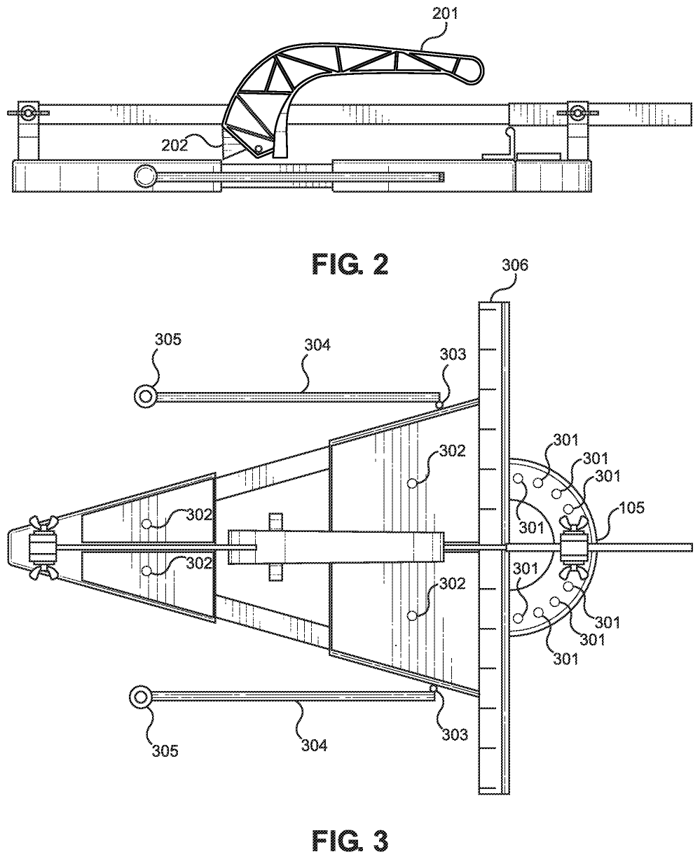

Referring now to FIG. 2, there is shown a side view of an embodiment of the tile cutting hand tool. The slide bar 103 has a handle 201 slidably attached thereto. The handle 201 is configured to slide along the slide bar 103. In one embodiment, the handle 201 has a bend in it. This bend will allow for more pressure to be applied in a downward direction. The handle 201 has a blade 202 attached to an end closest to the planar base 101. In one embodiment, the blade 202 is a diamond blade. In another embodiment, the blade 202 is a steel blade. The blade 202 is configured to score tile when pressed into and slide across the tile.

Referring now to FIG. 3, there is shown a top down view of an embodiment of the tile cutting hand tool. In one embodiment, the planar base 101 has a ruler 306 attached thereto. The rule is configured to be perpendicular to the slide bar 103 when the bar is in the middle pin aperture 301. In one embodiment, the ruler 306 has a raised section to allow a tile to be pressed against it. This will ensure the tile is in the proper place before it is scored.

The planar base 101 has a plurality of pin apertures 301. The plurality of pin apertures 301 are configured to frictionally hold the pin on the bottom of the second connector 105 in place. In one embodiment, the different apertures (301?) are in a place to represent an angle relative to the ruler. This angle will represent the angle at which a tile will be scored.

In one embodiment, the planar base 101 has a plurality of apertures 302 placed therethrough. The apertures 302 are configured to have securement devices placed therethrough. In one embodiment, the securement devices are screws. In another embodiment, the securement devices are nails.

In one embodiment, the planar base 101 further has a pair of securement arms 304 attached thereto. In one embodiment, the securement arms 304 are attached with a hinge 303. This will allow the securement arms 304 to be placed at different positions relative to the planar base 101. The securement arms 304 have apertures 305 located at the end opposite the hinge 303. This will allow the securement arms 304 to be secured into position.

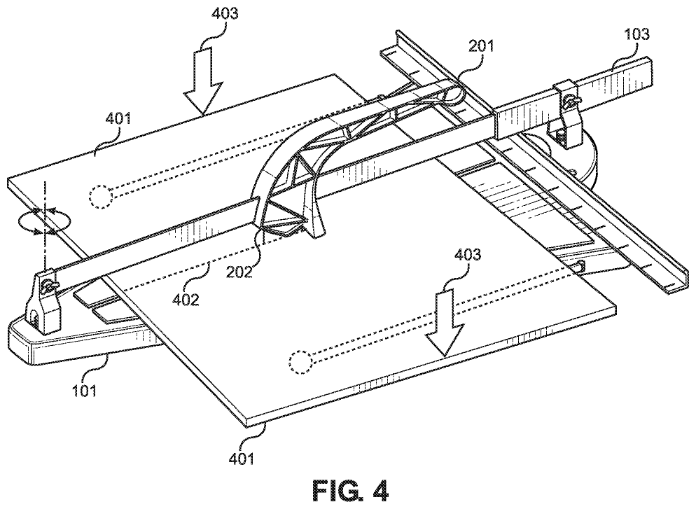

Referring now to FIG. 4, there is shown a perspective in use view of an embodiment of the tile cutting hand tool. In use, a tile 401 is placed upon the planar base 101. The tile will be placed such that the blade 202 is pressed into the tile 401. As the handle 201 is pulled along the slide bar 103 the tile 401 is scored 402. Once the length of the tile 401 is scored 402, pressure 403 is applied to the edges of the tile 401. The pressure 403 will cause the tile 401 to break along the score 402.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tile cutting hand tool, the tool comprising:
a planar base having at least a first side and a second side;
a first slide bar connector rising vertically from the planar base on the first side and a second slide bar connector rising vertically from the planar base on the second side;
a slide bar connected to the first slide bar connector and the second slide bar connector;
a scoring device slidably attached to the slide bar;
the scoring device having a handle and a scoring blade.

2) The tile cutting hand tool of claim 1, wherein the scoring blade is a diamond tip blade.

3) The tile cutting hand tool of claim 1, wherein the planar base ishas a taper from a first end to the second end.

4) The tile cutting hand tool of claim 1, further comprising a ruler placed on one side of the planar base, wherein the ruler is perpendicular to the guide bar.

5) The tile cutting hand tool of claim 1, further comprising a ruler placed on one side of the planar base, wherein the ruler is perpendicular with the slide bar.

6) The tile cutting hand tool of claim 1, wherein the first slide bar connector and the second slide bar connector have adjustable heights.

7) The tile cutting hand tool of claim 1, further comprising a pair of base supports located on a bottom side of the planar base.

8) The tile cutting hand tool of claim 7, wherein the base supports allow for the tool to be extended telescopically.

9) The tile cutting hand tool of claim 8, wherein the base supports are telescopic.

10) The tile cutting hand tool of claim 1, wherein the planar base has a plurality of apertures placed therethrough to allow for a securing device to be placed therein.

11) A tile cutting hand tool, the tool comprising:
a planar base having at least a first side and a second side;
a first guide bar connector rising vertically from the planar base on the first side and a second guide bar connector rising vertically from the planar base on the second side;
a guide bar connected to the first guide bar connector and the second guide bar connector;
the second guide bar connector is adjustable such that the guide bar can be placed at an angle relative to the center of the device;
a scoring device slidably attached to the guide bar;
the scoring device having a handle and a scoring blade.

12) The tile cutting hand tool of claim 11, wherein the scoring blade is a diamond tip blade.

13) The tile cutting hand tool of claim 11, further comprising a protractor attached to the planar base, wherein the protractor can measure the angle of the guide bar.

14) The tile cutting hand tool of claim 11, further comprising a ruler placed on one side of the planar base, wherein the ruler is perpendicular to the guide bar.

15) The tile cutting hand tool of claim 11, further comprising a ruler placed on one side of the planar base, wherein the ruler is horizontal with the guide bar.

16) The tile cutting hand tool of claim 11, wherein the first guide bar connector and the second guide bar connector have adjustable heights.

17) The tile cutting hand tool of claim 11, further comprising a pair of base supports located on a bottom side of the planar base.

18) The tile cutting hand tool of claim 17, wherein the base supports allow for the tool to be extended.

19) The tile cutting hand tool of claim 18, wherein the base supports are telescopic.

20) The tile cutting hand tool of claim 19, wherein the planar base has a plurality of apertures placed therethrough to allow for a securing device to be placed therein.
